(19) United States
(12) Patent Application Publication
(10) Pub. No.: US 2009/0077235 A1
(43) Pub. Date: Mar. 19, 2009

(54) MECHANISM FOR PROFILING AND ESTIMATING THE RUNTIME NEEDED TO EXECUTE A JOB

(75) Inventor: Sharma R. Podila, Santa Clara, CA (US)

Correspondence Address: HICKMAN PALERMO TRUONG & BECKER, LLP;AND SUN MICROSYSTEMS, INC., 2055 GATEWAY PLACE, SUITE 550, SAN JOSE, CA, 95110-1089, US

(73) Assignee: SUN MICROSYSTEMS, INC., Santa Clara, CA (US)

(21) Appl. No.: 11/858,056

(22) Filed: Sep. 19, 2007

(51) Int. Cl. G06F 15/173

(52) U.S. Cl. 709/226

(57) ABSTRACT

A mechanism is provided for estimating the amount of time needed to execute a job. The mechanism receives a request to execute a new job. The mechanism processes the request to determine the job profile signature for the new job, which is based on a set of job characteristics of the new job. The mechanism also selects a candidate machine from a plurality of machines in a computing grid which contains an available time slot, and determines a machine profile signature for the candidate machine based on a set of machine characteristics of the candidate machine. The mechanism accesses and obtains from a database execution estimation information based on actual execution information associated with previously executed jobs having identical job profile signatures as the new jobs and which have been executed on machines having identical machine profile signatures as the candidate machine. Based on this execution estimation information, the mechanism derives an estimate of the amount of time need to execute the new job. By estimating the execution time in this manner, the mechanism enhances scheduling efficiencies for jobs submitted to the computing grid.

### BACKGROUND

In recent years, there has been a movement in the computing industry toward the implementation of computing grids. In a computing grid, a plurality of distributed computing machines, each with its own set of processors, memories, and system resources, are interconnected and shared. These computing machines may be dynamically allocated by a job scheduler for purposes of executing jobs. For example, the scheduler may assign a first machine with two processors to execute one job and a second machine with four processors to execute another job. The scheduler provides a centralized mechanism for assigning a large number of jobs to a large number of job-executing machines.

However, in order for the scheduler to efficiently schedule jobs in the future, it is vital that job execution times be reliably estimated and predicted. For example, a scheduler may receive a request that a particular job requiring a specific type of license and a specific number of processors be scheduled. The scheduler finds out that the specific type of license is currently being used by another job. If the execution time of the current job can be accurately estimated, the scheduler can then schedule the particular job for a time slot after the current job is estimated to finish. For example, if the current job is estimated to finish in two hours, then the scheduler can schedule the particular job on a machine with the specific number of processors for a time slot two hours later.

In addition, while the machine with the specific number of processors is waiting for execution of a future job to commence, if another job can be scheduled and executed on the otherwise idle machine, resource usage efficiency for the computing grid would be greatly increased. However, this “backfilling” technique requires that the later-scheduled job must finish execution before the end of two hours. Therefore, for this backfilling technique to succeed, it is also vital that job execution times be reliably estimated and predicted.

Therefore, it is desirable to provide techniques and mechanisms for accurately estimating job execution times.

### SUMMARY

In accordance with one embodiment of the present invention, there is provided a mechanism for estimating the execution times of jobs on machines in a computing grid based on the characteristics of the jobs, the characteristics of the machines, and the historical execution times of jobs on the machines.

In one embodiment, the mechanism operates as follows. Initially, the mechanism receives a request to execute a new job. The mechanism processes the request to determine a job profile signature for the new job, which is based on a set of job characteristics for the new job. The mechanism then selects a candidate machine from the computing grid with an available time slot and determines a machine profile signature for the candidate machine. The machine profile signature for the candidate machine is based on a set of machine characteristics for the candidate machine.

Next, the mechanism accesses a database containing execution estimation information for a plurality of previously executed jobs. This execution estimation information includes, among other types of information, execution time information. More specifically, the mechanism accesses execution estimation information associated with jobs that have the same job profile signature as the new job and that have been executed on machines that have the same machine profile signature as the candidate machine. From this execution estimation information, the mechanism determines whether the new job can be fully executed by the candidate machine within the available time slot.

If the mechanism determines that the new job cannot be fully executed, a new candidate machine with another available time slot is selected. On the other hand, if the mechanism determines that the new job can be fully executed by the candidate machine within the available time slot, then the new job is scheduled for execution on the candidate machine in the available time slot. After execution of the new job is completed, the actual execution information for the new job is stored in the database, where the actual execution information is associated with the job profile signature of the new job and the machine profile signature of the candidate machine. In this manner, the database is updated with actual execution information of jobs as the jobs are completed.

As discussed above, based at least partially upon the actual execution times for completed jobs, the mechanism derives an estimate of the execution time of new jobs. Because this estimation is based on information specific to particular job profile signatures and particular machine profile signatures, it is much more accurate than other crude methods of estimates previously employed. Therefore, this mechanism provides fast, simple, and accurate estimates of job execution times for jobs submitted for execution on a computing grid of a plurality of machines.

### BRIEF DESCRIPTION OF THE DRAWINGS

FIG. 1 is a functional block diagram of a system in which one embodiment of the present invention may be implemented.

FIG. 2 is an operational flow diagram illustrating the manner in which the system of FIG. 1 operates in accordance with one embodiment of the present invention.

FIG. 3 is a block diagram of a general purpose computer system in which one embodiment of the present invention may be implemented.

### DETAILED DESCRIPTION OF THE EMBODIMENT(S)

### System Overview

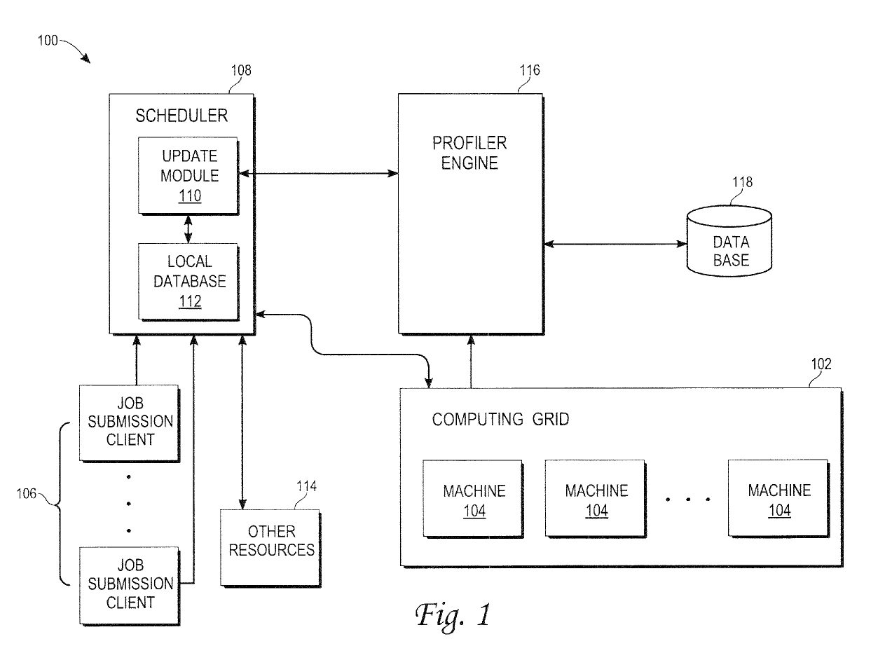

FIG. 1 shows a functional block diagram of a system 100 in which one embodiment of the present invention may be implemented. It should be noted that the system of FIG. 1 is shown for illustrative purposes only. If so desired, the concepts taught herein may be applied to other systems having different configurations.

### Computing Grid

As shown in FIG. 1, the system 100 comprises a computing grid 102. In one embodiment, the computing grid 102 comprises a plurality of machines 104. The machines in the plurality of machines 104 may contain different types of processors, different numbers of processors, different amounts of memory, different system architectures, different operating systems, and other different characteristics. The computing grid 102 is the computing resource of system 100. Jobs submitted in system 100 are therefore executed on the plurality of machines 104 in computing grid 102. System 100 also includes a scheduler 108, which is responsible for scheduling jobs submitted in the system 100.

### Submitting Jobs and Job Profile Signatures

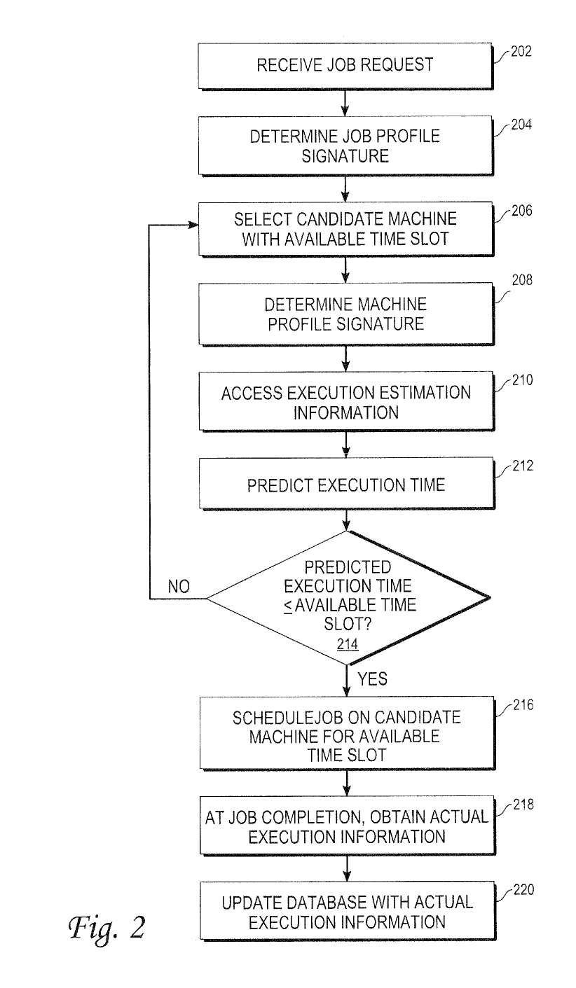

To describe how system 100 estimates the execution times of submitted jobs, reference will be made to the flow diagram of FIG. 2 as well as to the system diagram of FIG. 1. In one embodiment, the scheduler 108 receives (block 202) one or more job requests from one or more job submission clients 106. In response to a new job request, the scheduler 108 processes the request to determine the job profile signature for the new job (block 204). The job profile signature for a new job is determined based on a set of job characteristics associated with the new job, such as the number of processors requested by the job and the name of the user who submitted the job (more details on job characteristics are provided below). In one embodiment, a job profile signature is based upon for a specific set of job characteristics. That is, two jobs will have the same job profile signature if and only if the job characteristics associated with the two jobs match exactly. For example, in an embodiment where the job profile signature is determined from two job characteristics (the number of processors requested by the job and the name of the user who submitted the job), two jobs will have the same job profile signature if and only if both jobs request the same number of processors and were submitted by the same user. In determining the job profile signature for a new job, the scheduler 108 may parse the job request and interpret the items extracted from the parsed job request to obtain the job characteristics associated with the new job.

The set of job characteristics examined by the scheduler 108, for the purpose of generating a job profile signature, may contain any number of attributes that characterize a job, such as, for example: the name of the user who submitted the job, the name of the project associated with the job, the type of job, the number of processors requested by the job, the amount of memory requested by the job, the names and numbers of licenses requested by the job, the operating system on which the job is to be executed, the amount of local disk space requested by the job, and the job priority. The “project name”, “type of job”, and “job priority” characteristics may be user-defined. Various embodiments of the present invention may utilize any combination of the job characteristics listed above or other unlisted job characteristics as the set of job characteristics from which job profile signatures are generated. The use of the job profile signature provides a simple and elegant way to reduce the complexity of identifying commonalties between jobs. Therefore, the choice of which job characteristics to include in the set of job characteristics from which job profile signatures are generated may vary from one embodiment to another, depending on which job characteristic commonalties are appropriate for the particular embodiment.

Finally, although the description for the embodiment in FIG. 1 discloses that the scheduler 108 is responsible for generating the job profile signature for new jobs, this functionality may be implemented elsewhere in the system 100 as long as the scheduler 108 has access to job profile signatures for new jobs. For example, job submission clients 106 may be given the responsibility of generating job profile signatures. In this example, the job submission clients 106 submit new jobs to the scheduler 108 along with the associated job profile signatures.

### Candidate Machines and Machine Profile Signatures

In one embodiment, after the scheduler 108 has determined the job profile signature for a new job, the scheduler 108 selects a candidate machine from the plurality of machines 104 in computing grid 102 for execution of the new job (block 206). Specifically, scheduler 108 selects a candidate machine that has an available time slot in which the new job may be scheduled. Furthermore, system 100 may also contain other resources 114 that are needed for execution of the new job. Other resources 114 may include, for example, licenses for software needed to execute the new job.

After a candidate machine is selected, the scheduler 108 determines the machine profile signature of the candidate machine (block 208). A machine profile signature for a particular machine is determined based on a set of machine characteristics for the particular machine. Machine characteristics can include, for example: the number of processors on a machine, the amount of memory on a machine, the amount of swap space available on a machine, the CPU frequency, the type of CPU, the system frequency, the system bus speed, and the operating system on the machine. The machine profile signature for a candidate machine may be derived anew from the candidate machine's machine characteristics each time the candidate machine is selected. Alternatively, the machine profile signature for each machine in the computing grid 102 may be stored for easy retrieval by the scheduler 108, so that the scheduler 108 need not re-derive the machine profile signature every time a candidate machine is selected.

### Predicting Execution Time Based on Execution Estimation Information

Using the job profile signature of the new job and the machine profile signature of the candidate machine as references, the scheduler 108 accesses a local database 112 to extract execution estimation information (Block 210). The execution estimation information in local database 112 is stored on a per-combination of job profile signature and machine profile signature basis. In other words, each set of execution estimation information in local database 112 is associated with a particular job profile signature and a particular machine profile signature. Therefore, in Block 210, the scheduler 108 extracts execution estimation information specific to the job profile signature of the new job and the machine profile signature of the candidate machine. In one embodiment, local database 112 is implemented as a table with a constant look-up time to facilitate quick retrieval of information by the scheduler 108.

The execution estimation information stored in local database 112 is based upon actual execution information from previously executed jobs. The updating of local database 112 with actual execution information from newly executed jobs is discussed in further detail in a later section. In one embodiment, the execution estimation information stored in local database 112 contains statistical information for a plurality of data values collected from previously executed jobs. Data values collected from a previously executed job may represent the amount of total execution time, amount of CPU execution time, and maximum amount of memory used. Statistical information for a data value may include the statistical mean, the statistical median, and the standard deviation for that data value. For example, the execution estimation information retrieved by the scheduler 108 for a particular job profile signature and a particular machine profile signature may include the statistical mean, the statistical median, and the standard deviation for each of the amount of total execution time, amount of CPU execution time, and maximum amount of memory used for all previously executed jobs with the particular job profile signature, which have been executed on machines with the particular machine profile signature. Overall, the scheduler 108 retrieves statistical information about historical runtime data for jobs whose job profile signatures match with the job profile signature of the new job, and which have been executed on machines whose machine profile signatures match with the machine profile signature of the candidate machine. This statistical information is the basis upon which the scheduler 108 makes a prediction for the execution time of the new job on the candidate machine.

In the present invention, the scheduler 108 may employ various schemes in predicting an execution time for the new job on the candidate machine from the retrieved execution estimation information (Block 212). In one embodiment, the predicted execution time is simply the statistical mean of total execution times. In another embodiment, the predicted execution time is the amount of time within which ninety-percent of previously executed jobs have finished. This percentage can be increased or decreased to heighten or lower the confidence level of a predicted execution time. Therefore, using the statistical information retrieved from local database 112, the scheduler 108 may use a variety of prediction schemes to achieve a variety of desired levels of confidence.

### Scheduling and Re-selecting a Candidate Machine

Once the scheduler 108 has predicted an execution time, a determination may be made as to whether the predicted execution time is shorter than or equal to the available time slot on the candidate machine (Block 214). If the predicted execution time is shorter than or equal to the available time slot, then the new job is estimated to be able to finish within the available time slot, and the scheduler 108 schedules the new job in that time slot on the candidate machine (Block 216). On the other hand, if the predicted execution time is longer than the available time slot, a new candidate machine is selected (Block 206), and Blocks 208, 210, and 212 are repeated. This process may be repeated until a candidate machine is found whose available time slot is longer than the predicted execution time for the new job and the particular candidate machine.

### Updating Execution Estimation Information

Once the new job has been scheduled (Block 218), it is queued to be executed by the candidate machine, which is one of the plurality of machines 104 in computing grid 102. When the new job has completed execution on the candidate machine, data for this newly executed job is collected (Block 218), and execution estimation information is updated (Block 220).

First, the computing grid 102 sends actual execution information for a newly executed job to a profiler engine 116 in system 100. In one embodiment, the profiler engine 116 is the central component in maintaining execution estimation information for jobs executed in computing grid 102. As an overview, profiler engine 116 is responsible for collecting actual execution information for newly executed jobs, updating statistical information to incorporate such actual execution information for newly executed jobs, interfacing with database 118 to retrieve and store both actual execution information and execution estimation information, and interfacing with the estimation information update module 110 to periodically update local database 112 in scheduler 108.

The actual execution information sent from computing grid 102 to profiler engine 116 includes data values representing the amount of total execution time, amount of CPU execution time, and maximum amount of memory used by the newly executed job. Furthermore, computing grid 102 also sends information regarding the job profile signature for the newly executed job and the machine profile signature for the machine on which the newly executed job was executed. In one embodiment, these signatures were received at the computing grid 102 from scheduler 108 upon the scheduling or commencement of execution of the newly scheduled job. Therefore, at the completion of Block 218, the profiler engine 116 has received the actual execution information for a newly executed job and the job profile signature and machine profile signature associated with the newly executed job.

Next, profiler engine 116 stores to database 118 actual execution information for the newly executed job. Database 118 is therefore updated with new data of actual execution information for a job every time a job is completed in computing grid 102 (Block 220).

At the end of Block 220, a new job request has been processed to predict an execution time, the execution time has been used in scheduling the new job in a time slot on a machine, the new job has been completed, and a database containing actual execution information for completed jobs has been updated. The following sections discuss the operations performed asynchronous to the steps in the flow diagram in FIG. 2 and other variations in the present invention.

### Calculating Execution Estimation Information

Execution estimation information includes statistical information for data values representing the amount of total execution time, amount of CPU execution time, and maximum amount of memory used by previously executed jobs which have the same job signature profile as the newly executed job, and which have been executed on machines with the same machine signature profile as the machine on which the newly executed job has been executed. Statistical information for each data value includes the statistical mean, the statistical median, and the standard deviation for that data value.

Profiler engine 116 calculates execution estimation information by retrieving, from database 118, the most updated actual execution information for combinations of job profile signatures and machine profile signatures, and calculating statistical information based on this actual execution information. Some additional information, such as the total number of jobs executed for a particular combination of job profile signature and machine profile signature, may also be stored and updated in database 108 to facilitate the calculation of statistical information.

The calculation of execution estimation information may be performed by profiler engine 116 every time a job is completed or only when periodically updating local database 112, as described in further detail below.

### Updating the Local Database in the Scheduler

As discussed above, profiler engine 116 and database 118 are dedicated to the tasks of updating and storing actual execution information from newly completed jobs, and perform such updating and storing every time a new job is completed. In addition, execution estimation information incorporating the most recently completed jobs is calculated by the profiler engine 116. Scheduler 108 accesses recent execution estimation information by accessing local database 112, which is periodically updated with the execution estimation information from profiler engine 116.

As illustrated in FIG. 1, local database 112 is updated when the profiler engine 116 sends updated execution estimation information to local database 112. In one embodiment, an update module 110 in scheduler 108 operating asynchronously with respect to the main scheduling operation periodically requests for updated information from the profile engine 116. Alternatively, profiler engine 116 may periodically automatically send updated execution information to update module 110. As discussed above, the calculation of execution estimation information may be performed by profiler engine 116 every time a job is completed or only immediately before sending updated information to local database 112. In summary, local database 112 is updated periodically with the most recent execution estimation information through interfacing with update module 110 and profiler engine 116. At the same time and asynchronously, scheduler 108 reads local database 112 to access the last updated execution information in local database 112 to predict execution times for new jobs. This scheme of providing asynchronously and periodically updated execution estimation information to scheduler 108 allows the scheduler to schedule jobs at a near-real time speed. Alternatively, the scheduler 108 and the profiler engine 106 may be combined into one component in system 100.

### Variations in Statistical Analysis

In one embodiment, data values which are “statistical outliers” are discarded by the profiler engine 116 and are not used to update the statistical information for previously executed jobs stored in database 118. Statistical outliers are data values which are much higher or much lower than the range of historic data values, and are likely to have been the result of exceptional circumstances such as machine failures that caused a job to be terminated very quickly, or infinite loops in a job that caused a job to run for a very long time. As such, these statistical outliers do not usefully indicate how jobs execute under normal circumstances. In fact, if incorporated into historical statistical information, these statistical outliers may distort indications of how jobs execute under normal circumstances. Therefore, in one embodiment, statistical outliers are detected by the profiler engine 116 and are then discarded.

In one embodiment, only the actual execution information from the most recently executed jobs are incorporated into the statistics that are eventually provided to the scheduler 108 for the purpose of predicting execution times for new jobs. This feature is desirable because estimates based on the most recent actual execution information are likely to be more accurate. For example, the same kind of jobs may be submitted over a period of time for a particular project, where the jobs all have the same job profile signature. However, over the period of time, as the project progresses from rudimentary modeling to full modeling, for example, the jobs submitted may become increasingly complex and therefore incur increasingly longer execution times. If statistics for these jobs continue to weigh actual execution time from the earliest completed jobs and the actual execution time from the most recently completed jobs equally, scheduler 108's prediction of job execution time for new jobs will often underestimate the job execution time. Therefore, by using a shifting “window” of time where data from only the most recently completed jobs are used to calculate statistical information, a more accurate prediction of execution time is achieved.

Finally, a minimum threshold may be set so that statistical information is used to predict execution times only if the statistical information for a particular combination of job profile signature and machine profile signature is based on at least a specific number of jobs. Setting a minimum threshold prevents the situation where execution times are inaccurately predicted because the underlying statistical information on which predictions are made is based on a small set of unrepresentative data. In one embodiment, for a particular combination of job profile signature and machine profile signature, if the number of previously completed jobs is less than the minimum threshold, the scheduler 108 uses a default execution time as the predicted execution time.

### Hardware Overview

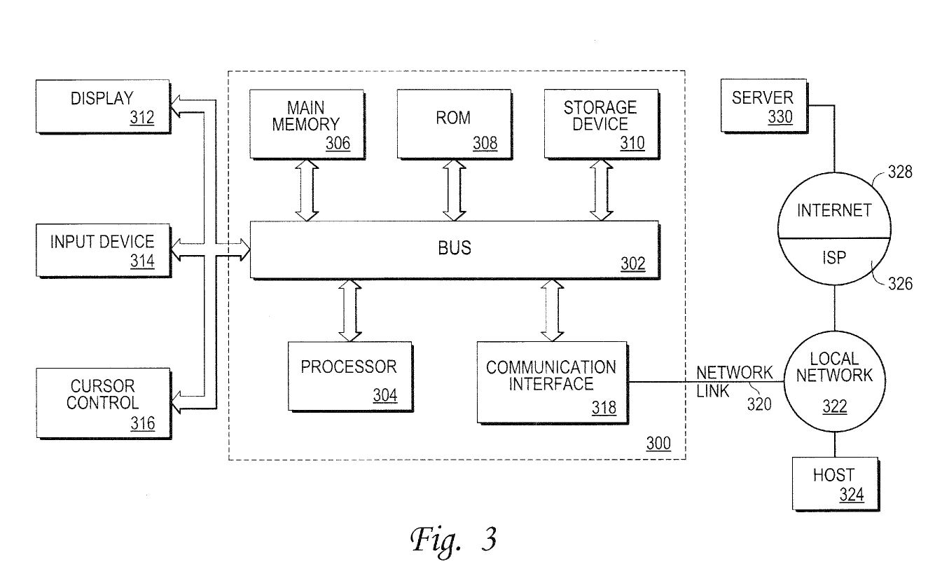

In one embodiment, the DRM 112 and the resource estimator 114 may take the form of sets of instructions that are executed by one or more processors. In such a form, they may be executed by the computing grid 102 or by a separate computer system, such as the system shown in FIG. 3. Computer system 300 includes a bus 302 for facilitating information exchange, and one or more processors 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions by processor 304. Computer system 300 may further include a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312 for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

In computer system 300, bus 302 may be any mechanism and/or medium that enables information, signals, data, etc., to be exchanged between the various components. For example, bus 302 may be a set of conductors that carries electrical signals. Bus 302 may also be a wireless medium (e.g. air) that carries wireless signals between one or more of the components. Bus 302 may further be a network connection that connects one or more of the components. Any mechanism and/or medium that enables information, signals, data, etc., to be exchanged between the various components may be used as bus 302.

Bus 302 may also be a combination of these mechanisms/media. For example, processor 304 may communicate with storage device 310 wirelessly. In such a case, the bus 302, from the standpoint of processor 304 and storage device 310, would be a wireless medium, such as air. Further, processor 304 may communicate with ROM 308 capacitively. Further, processor 304 may communicate with main memory 306 via a network connection. In this case, the bus 302 would be the network connection. Further, processor 304 may communicate with display 312 via a set of conductors. In this instance, the bus 302 would be the set of conductors. Thus, depending upon how the various components communicate with each other, bus 302 may take on different forms. Bus 302, as shown in FIG. 3, functionally represents all of the mechanisms and/or media that enable information, signals, data, etc., to be exchanged between the various components.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, DVD, or any other optical storage medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution. In this manner, computer system 300 may obtain application code in the form of a carrier wave. At this point, it should be noted that although the invention has been described with reference to a specific embodiment, it should not be construed to be so limited. Various modifications may be made by those of ordinary skill in the art with the benefit of this disclosure without departing from the spirit of the invention. For example, in FIG. 1, the windowing service 190 and the label comparator 192 are shown as separate components. While this is one possible embodiment, it should be noted that other embodiments are also possible. For example, the functionality of the label comparator 192 may be incorporated into the windowing service 190, the kernel 150, or some other component. These and other modifications are within the scope of the present invention. Thus, the invention should not be limited by the specific embodiments used to illustrate it but only by the scope of the issued claims and the equivalents thereof.

What is claimed is:

1. A machine implemented method, comprising:
receiving a request to execute a new job, the new job having a job profile signature which is composed based upon a plurality of job characteristics of the new job;
selecting a candidate machine on which the new job may be executed, the candidate machine having a machine profile signature which is composed based upon a plurality of machine characteristics of the candidate machine, the candidate machine having an available time slot in which the new job may be executed;
accessing, based at least partially upon the job profile signature of the new job and the machine profile signature of the candidate machine, a set of execution estimation information which provides an estimate of how much time will be needed to execute the new job on the candidate machine, wherein the set of execution estimation information is derived based upon actual execution information from previously executed jobs, wherein the previously executed jobs had the same job profile signature as the new job and were executed on machines having the same machine profile signature as the candidate machine;
determining, based at least partially upon the set of execution estimation information, whether the new job can be fully executed by the candidate machine within the available time slot; and
in response to a determination that the new job can be fully executed by the candidate machine within the available time slot, scheduling the new job to be executed by the candidate machine within the available time slot.

2. The method of claim 1, further comprising:
obtaining, after the new job has been executed, a set of actual execution information for the new job, wherein the actual execution information for the new job comprises an amount of time actually consumed by the candidate machine in executing the new job; and
storing the set of actual execution information for the new job into a database in association with the job profile signature of the new job and the machine profile signature of the candidate machine.

3. The method of claim 2, further comprising:
retrieving from the database actual execution information for a plurality of already executed job, including the new job, wherein the already executed jobs have the same job profile signature as the new job and were executed on machines having the same machine profile signature as the candidate machine;
based upon the actual execution information for the already executed jobs, deriving an updated set of execution estimation information; and
updating the set of execution estimation information with the updated set of execution estimation information.

4. The method of claim 3, wherein the set of execution estimation information comprises an average execution time, and wherein deriving the updated set of execution estimation information comprises:
deriving an updated average execution time.

5. The method of claim 3, wherein the set of execution estimation information further comprises a median execution time, and wherein deriving the updated set of execution estimation information further comprises:
deriving an updated median execution time.

6. The method of claim 3, wherein the set of execution estimation information further comprises a standard deviation, and wherein deriving the updated set of execution estimation information further comprises:
deriving an updated standard deviation.

7. The method of claim 1, wherein the plurality of job characteristics of the new job used to compose the job profile signature of the new job include at least three of:
an identity of a user submitting the new job;
a project name;
a job type;
a number of CPUs requested by the user; and
an amount of memory requested by the user.

8. The method of claim 7, wherein the plurality of job characteristics of the new job used to compose the job profile signature of the new job further include at least two of:
an identity of a license for an application requested by the user;
a number of licenses for the application requested by the user;
an operating system requested by the user;
an amount of local disk space requested by the user; and
a priority requested by the user.

9. The method of claim 1, wherein the plurality of machine characteristics of the candidate machine used to compose the machine profile signature of the candidate machine include at least three of:
a number of CPUs in the candidate machine;
an amount of memory in the candidate machine;
a processor frequency of a CPU in the candidate machine;
a system frequency of the candidate machine; and
a system bus speed of the candidate machine.

10. The method of claim 9, wherein the plurality of machine characteristics associated with the candidate machine used to compose the machine profile signature of the candidate machine include at least one of:
an amount of swap space in the candidate machine; and
an operating system of the candidate machine.

11. An apparatus comprising:
a mechanism for receiving a request to execute a new job, the new job having a job profile signature which is composed based upon a plurality of job characteristics of the new job;
a mechanism for selecting a candidate machine on which the new job may be executed, the candidate machine having a machine profile signature which is composed based upon a plurality of machine characteristics of the candidate machine, the candidate machine having an available time slot in which the new job may be executed;
a mechanism for accessing, based at least partially upon the job profile signature of the new job and the machine profile signature of the candidate machine, a set of execution estimation information which provides an estimate of how much time will be needed to execute the new job on the candidate machine, wherein the set of execution estimation information is derived based upon actual execution information from previously executed jobs, wherein the previously executed jobs had the same job profile signature as the new job and were executed on machines having the same machine profile signature as the candidate machine;
a mechanism for determining, based at least partially upon the set of execution estimation information, whether the new job can be fully executed by the candidate machine within the available time slot; and
a mechanism for scheduling the new job to be executed by the candidate machine within the available time slot in response to a determination that the new job can be fully executed by the candidate machine within the available time slot.

12. The apparatus of claim 11, further comprising:
a mechanism for obtaining, after the new job has been executed, a set of actual execution information for the new job, wherein the actual execution information for the new job comprises an amount of time actually consumed by the candidate machine in executing the new job; and
a mechanism for storing the set of actual execution information for the new job into a database in association with the job profile signature of the new job and the machine profile signature of the candidate machine.

13. The apparatus of claim 12, further comprising:
a mechanism for retrieving from the database actual execution information for a plurality of already executed job, including the new job, wherein the already executed jobs have the same job profile signature as the new job and were executed on machines having the same machine profile signature as the candidate machine;
a mechanism for deriving an updated set of execution estimation information based upon the actual execution information for the already executed jobs; and
a mechanism for updating the set of execution estimation information with the updated set of execution estimation information.

14. The apparatus of claim 13, wherein the set of execution estimation information comprises an average execution time, and wherein the mechanism for deriving the updated set of execution estimation information comprises:
a mechanism for deriving an updated average execution time.

15. The apparatus of claim 13, wherein the set of execution estimation information further comprises a median execution time, and wherein the mechanism for deriving the updated set of execution estimation information further comprises:
a mechanism for deriving an updated median execution time.

16. The apparatus of claim 13, wherein the set of execution estimation information further comprises a standard deviation, and wherein the mechanism for deriving the updated set of execution estimation information further comprises:
a mechanism for deriving an updated standard deviation.

17. The apparatus of claim 1, wherein the plurality of job characteristics of the new job used to compose the job profile signature of the new job include at least three of:
an identity of a user submitting the new job;
a project name;
a job type;
a number of CPUs requested by the user; and
an amount of memory requested by the user.

18. The apparatus of claim 17, wherein the plurality of job characteristics of the new job used to compose the job profile signature of the new job further include at least two of:
an identity of a license for an application requested by the user;
a number of licenses for the application requested by the user;
an operating system requested by the user;
an amount of local disk space requested by the user; and
a priority requested by the user.

19. The apparatus of claim 11, wherein the plurality of machine characteristics of the candidate machine used to compose the machine profile signature of the candidate machine include at least three of:
a number of CPUs in the candidate machine;
an amount of memory in the candidate machine;
a processor frequency of a CPU in the candidate machine;
a system frequency of the candidate machine; and
a system bus speed of the candidate machine.

20. The apparatus of claim 19, wherein the plurality of machine characteristics associated with the candidate machine used to compose the machine profile signature of the candidate machine include at least one of:
an amount of swap space in the candidate machine; and
an operating system of the candidate machine.
